(19) United States
(12) Patent Application Publication
(10) Pub. No.: US 2022/0049735 A1
(43) Pub. Date: Feb. 17, 2022

(54) PANELS WITH EDGE REINFORCEMENT

(71) Applicant: Välinge Innovation AB, Viken (SE)

(72) Inventor: Thomas MEIJER, Viken (SE)

(73) Assignee: Välinge Innovation AB, Viken (SE)

(21) Appl. No.: 17/398,416

(22) Filed: Aug. 10, 2021

(30) Foreign Application Priority Data
Aug. 12, 2020 (SE) 2050948-5

(51) Int. Cl. F16B 12/24; F16B 12/46; A47B 47/04

(52) U.S. Cl. CPC F16B 12/24; A47B 47/042; F16B 12/46

(57) ABSTRACT

A set of panels including a first panel, a second panel and a mechanical locking device for locking the first panel to the second panel. The first panel includes a first edge and a first panel surface and the second panel includes a second edge and a second panel surface. The first edge includes a first edge reinforcement in a first edge reinforcement groove, wherein the first edge reinforcement groove is a first drill hole, and/or the second edge includes a second edge reinforcement, wherein the second edge reinforcement is in a second edge reinforcement groove, wherein the second edge reinforcement groove is a second drill hole.

### CROSS REFERENCE TO RELATED APPLICATIONS

The present application claims the benefit of Swedish Application No. 2050948-5, filed on Aug. 12, 2020. The entire contents of Swedish Application No. 2050948-5 are hereby incorporated herein by reference in their entirety.

### TECHNICAL FIELD

Embodiments of the present disclosure relate to panels configured to be locked together with a mechanical locking device. The panels may be panels that may be assembled and locked together to obtain a furniture product, such as a bookshelf, a cupboard, a wardrobe, a box, a drawer or a furniture component and may thereafter be dismantled. The panels may also be floorboards to be locked together to obtain a floor product.

### TECHNICAL BACKGROUND

A furniture product provided with a mechanical locking device is known in the art, as evidenced by WO2012/154113 or WO2015/105449. The furniture products earlier described comprise a first panel connected perpendicular to a second panel by a mechanical locking device comprising a flexible tongue in an insertion groove.

Panels are known that are configured to be assembled by a vertical displacement and to be locked together in a vertical direction and in a horizontal direction. Such panels are disclosed in e.g., WO2014/209213 or WO2018/063047. A tongue and groove connection locks a first edge of a first panel to a second edge of the second panel. The first and the second edge furthermore comprise a locking element configured to cooperate with a locking groove for locking in the vertical and the horizontal direction.

The above description of various known aspects is merely one characterization of such, and is not an admission that any of the above description is considered as prior art.

Embodiments of the present disclosure address a need to provide panels that can be assembled, which panels comprise a mechanical locking device and have an improved strength.

### Summary

It is an object of certain aspects of the present disclosure to provide an improvement over the above described techniques and known art. A specific objective is to improve assembling of panels, such as furniture panels and floorboards, locked together by a mechanical locking device. The panels may be a part of a furniture product, such as a furniture component, a drawer, a cupboard, a bookshelf, a wardrobe, a kitchen fixture, or a box. The panels may also be floorboards. The panels may be building panels and part of an assembled product.

A further object of at least certain aspects of the present disclosure is to facilitate assembling and disassembling of panels configured to be assembled with a locking device that is easy to manufacture and to use.

A further object of at least certain aspects of the present disclosure is to facilitate assembling of panels configured to be assembled with a locking device that is easy to use and install and which reduces the risk of incorrect installation thereof.

A further object of at least certain aspects of the present disclosure is to facilitate assembling of panels configured to be assembled in a more stable and aesthetic way.

A further object of at least certain objects of the present disclosure is to facilitate assembling of panels, wherein the panels have an improved strength to avoid that the panels break or crack, e.g., during assembly or disassembly.

At least some of these and other objects and advantages that will be apparent from the description have been achieved by a set of panels comprising a first panel, a second panel and a mechanical locking device for locking the first panel to the second panel, wherein the first panel comprises a first edge and a first panel surface and the second panel comprises a second edge and a second panel surface, wherein the first edge comprises a first edge reinforcement in a first edge reinforcement groove, wherein the first edge reinforcement groove is a first drill hole, and/or the second edge comprises a second edge reinforcement, wherein the second edge reinforcement is in a second edge reinforcement groove, wherein the second edge reinforcement groove is a second drill hole.

According to an aspect the mechanical locking device for locking the first panel to the second panel comprises a tongue at the first edge and a tongue groove at the second edge.

According to an aspect the tongue comprises the first edge reinforcement.

According to an aspect the tongue groove comprises the second edge reinforcement.

According to an aspect the first edge reinforcement and the second edge reinforcement cooperate in a locked position of the first panel and the second panel.

According to an aspect the first and/or the second edge reinforcement comprises wood, a wood composite, a polymer material such as a thermoplastic material selected from, e.g., PP or POM, a polymeric curing mass such as thermoset polymers selected from, e.g., polyurreas, polyurethanes, polyisocyanurates, or mixtures thereof.

According to an aspect the first and/or the second edge reinforcement is a pin, wherein the pin preferably is fixed to the first and/or second edge reinforcement groove with a glue, e.g., a PU, PVA or PVAc glue.

According to an aspect the center line of the first edge reinforcement groove is essentially parallel with the first panel surface of the first panel.

According to an aspect the center line of the second edge reinforcement groove is essentially parallel with the second panel surface of the second panel.

According to an aspect the center line of the first edge reinforcement groove is essentially perpendicular to the first panel surface of the first panel.

According to an aspect the center line of the second edge reinforcement groove is essentially perpendicular to the second panel surface of the second panel.

According to an aspect the first and/or second edge reinforcement is part of the mechanical locking device.

According to an aspect the mechanical locking device comprises a flexible tongue in an insertion groove.

According to an aspect the insertion groove is positioned in the second edge of the second panel.

According to an aspect the flexible tongue may have longitudinal shape and the insertion groove may have a longitudinal shape, wherein the flexible tongue is positioned in the insertion groove with its length direction parallel with the length direction of the insertion groove.

According to an aspect the length direction of the insertion groove is parallel with the second edge of the second panel.

According to an aspect a locking surface, configured to cooperate with the flexible tongue when the first and second panel are in a locked position, is located on the first and/or second edge reinforcement.

According to an aspect the insertion groove is positioned in the first and/or second edge reinforcement.

According to an aspect the core of the first and/or second panel comprises particleboard, MDF, HDF, OSB, WPC, plywood, solid wood and/or polymeric material, such as thermosetting plastic or thermoplastic such as PVC, PU or PET.

According to an aspect the core comprising polymeric material comprises fillers such as fly ash, calcium carbonate, wood shavings, wood dust, cement and/or gypsum.

According to a further aspect, provided is also a method of providing a first panel and/or a second panel with a first and/or second edge reinforcement, the first and/or second panel comprising a mechanical locking device, wherein the first panel comprises a first edge and a first panel surface and the second panel comprises a second edge and a second panel surface, comprising providing the first and/or second edge with a first and/or second edge reinforcement groove of a cylindrical shape, arranging the first and/or second edge reinforcement in the first and/or second edge reinforcement groove, and forming a mechanical locking device at the first and/or second edge by mechanical cutting such as milling or sawing.

According to an aspect the step of providing the first and/or second edge with a first and/or second edge reinforcement groove is done by drilling or milling.

According to an aspect the center line of the first and/or second edge reinforcement groove is essentially parallel to the first panel surface and the second panel surface, respectively, and perpendicular to the first edge and second edge, respectively.

According to an aspect the center line of the first and/or second edge reinforcement groove is essentially parallel to the first panel surface and the second panel surface, respectively, and at an acute angle to the first edge and second edge, respectively.

According to an aspect the arranging of the first and/or second edge reinforcement in the first and/or second edge reinforcement groove is done before the mechanical cutting.

According to an aspect the method comprises forming of the first and/or second edge reinforcement by mechanical cutting.

According to an aspect the core of the first and/or second panel may be a plastic core comprising thermosetting plastic or thermoplastic, e.g., vinyl, PVC, PU or PET. The plastic core may comprise fillers.

The first panel and/or the second panel may be provided with a decorative layer, such as a foil or a veneer, on one or more surfaces.

### BRIEF DESCRIPTION OF THE DRAWINGS

These and other aspects, features and advantages of which embodiments of the disclosure are capable of, will be apparent and elucidated from the following description of embodiments and aspects of the present disclosure, reference being made to the accompanying drawings, in which

FIGS. 1A-2B show a set comprising a first panel and a second panel according to an exemplary embodiment of the disclosure. The first panel comprises a first edge reinforcement in a first edge reinforcement groove and the second panel comprises a second edge reinforcement in a second edge reinforcement groove.

FIGS. 3A-4B show a set comprising a first panel and a second panel according to an exemplary embodiment of the disclosure. The first panel comprises a first edge reinforcement in a first edge reinforcement groove and the second panel comprises a second edge reinforcement in a second edge reinforcement groove. The set comprises a mechanical locking device comprising a tongue at the first edge of the first panel and a tongue groove at the second edge of the second panel. In FIG. 4A it is illustrated that the mechanical locking device comprises a flexible tongue in an insertion groove for locking of the first panel to the second panel.

FIGS. 5A-6C show a set comprising a first panel and a second panel according to an exemplary embodiment of the disclosure. According to this embodiment, only the second panel is provided with an edge reinforcement. In FIG. 6C it is illustrated that the mechanical locking device comprises a flexible tongue in an insertion groove for locking of the first panel to the second panel.

FIGS. 7A-7D show a second panel according to an exemplary embodiment of the disclosure, where FIGS. 7A-7B show the second panel having a second edge reinforcement in a second edge reinforcement groove, while FIGS. 7C-7D show the second panel having a second edge reinforcement in a second edge reinforcement groove and a mechanical locking device formed at the second edge.

FIGS. 8A-9B show a set comprising a first panel and a second panel according to an exemplary embodiment of the disclosure. The first panel comprises a first edge reinforcement in a first edge reinforcement groove and the second panel comprises a second edge reinforcement in a second edge reinforcement groove. The set comprises a mechanical locking device comprising a tongue at the first edge of the first panel and a tongue groove at the second edge of the second panel.

FIGS. 10A-11B show a set comprising a first panel and a second panel according to an exemplary embodiment of the disclosure. The center line of the first edge reinforcement groove is not essentially parallel with the first panel surface, but is angled in a direction towards the first panel surface. The center line of the second edge reinforcement groove is not essentially parallel with the second panel surface, but is angled in a direction towards the second panel surface.

FIGS. 12A-13B show a set comprising a first panel and a second panel according to an exemplary embodiment of the disclosure. The center line of the first edge reinforcement groove is not perpendicular to the first edge and the center line of the second edge reinforcement groove is not perpendicular to the second edge.

FIGS. 14A-16B show a first and a second panel according to an exemplary embodiment of the disclosure. The center line of the second edge reinforcement groove is not essentially parallel with the second panel surface but is essentially parallel with the second edge of the second panel.

FIG. 17 shows a first panel and a second panel according to an exemplary embodiment of the disclosure. The second edge reinforcement is not positioned in the center of the second panel, i.e., the center line of the second edge reinforcement groove differs from the center line of the second panel. The mechanical locking device may comprise a flexible tongue in an insertion groove for locking of the first panel to the second panel.

FIGS. 18A-19C show a first panel and a second panel according to an exemplary embodiment of the disclosure. The first panel comprises a first edge reinforcement in a first edge reinforcement groove and the second panel comprises a second edge reinforcement in a second edge reinforcement groove. The set comprises a mechanical locking device comprising a tongue at the first edge of the first panel and a tongue groove at the second edge of the second panel. The center line of the first edge reinforcement groove is essentially parallel with the first panel surface, and the center line of the second edge reinforcement groove is essentially parallel with the second panel surface.

FIGS. 20A-20C show a first panel and a second panel according to an exemplary embodiment of the disclosure. The first panel comprises a first edge reinforcement in a first edge reinforcement groove and the second panel comprises a second edge reinforcement in a second edge reinforcement groove. The set comprises a mechanical locking device comprising a tongue at the first edge of the first panel and a tongue groove at the second edge of the second panel. The center line of the first edge reinforcement groove is essentially parallel with the first panel surface, and the center line of the second edge reinforcement groove is essentially parallel with the second panel surface. The mechanical locking device comprises a flexible tongue in an insertion groove for locking of the first panel to the second panel.

FIGS. 21A-21C show a first and a second panel according to an exemplary embodiment of the disclosure. The center line of the first edge reinforcement groove is essentially parallel with the first panel surface of the first panel, while the center line of the second edge reinforcement groove is essentially parallel with the second edge of the second panel.

FIGS. 22A-22B show examples of edge reinforcements according to the present disclosure.

FIG. 22C shows a first panel according to an exemplary embodiment of the disclosure.

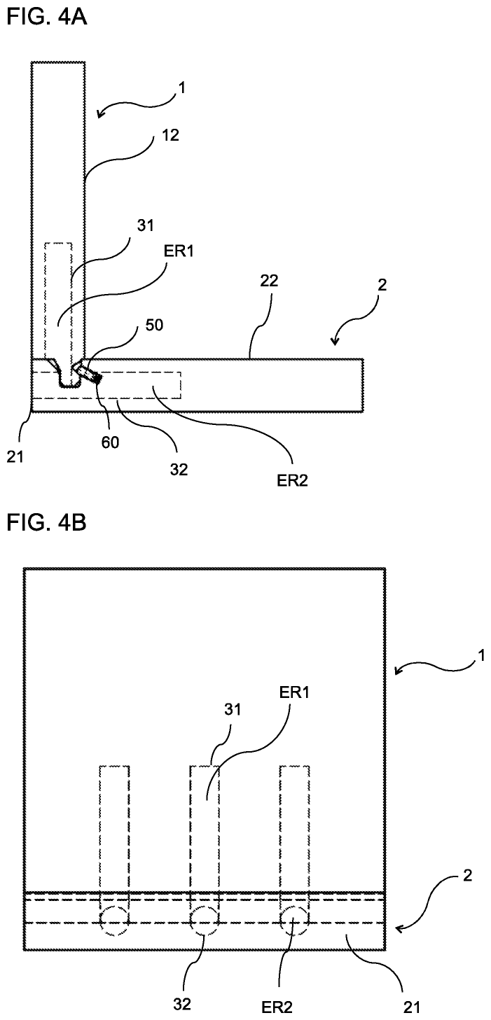

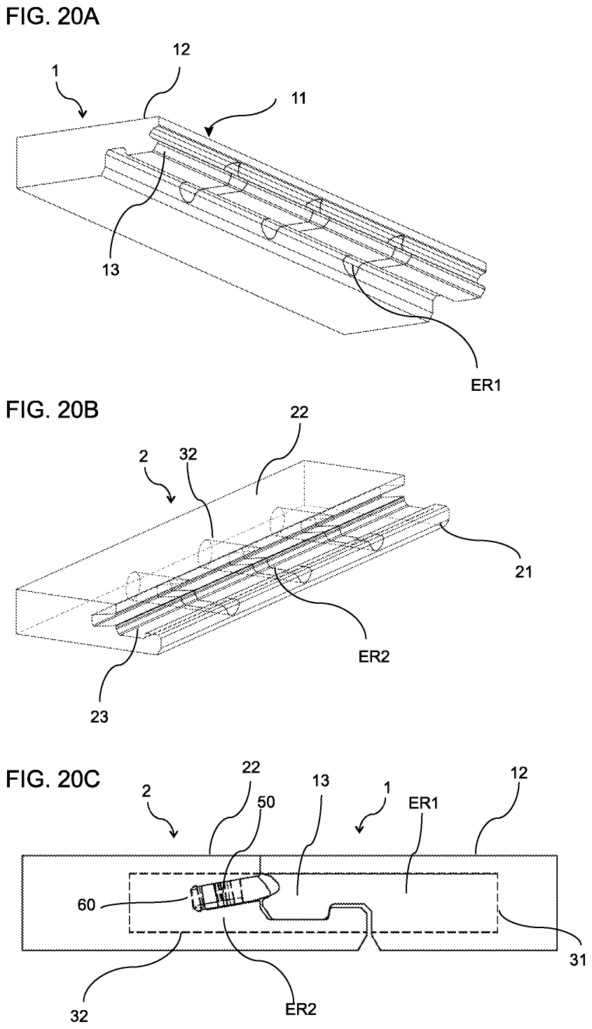

It is shown in FIGS. 4A, 6C, 17 and 20C that the mechanical locking device may comprise a flexible tongue positioned in an insertion groove, for locking of the first panel to the second panel. The rest of the figures showing the assembled first and second panel may also comprise a flexible tongue positioned in an insertion groove, but this is not shown in the figures.

### DETAILED DESCRIPTION

Specific embodiments of the disclosure will now be described with reference to the accompanying drawings. The subject matter of the application may, however, be embodied in many different forms and should not be construed as limited to the embodiments set forth herein. The terminology used in the detailed description of the embodiments illustrated in the accompanying drawings is not intended to be limiting of the invention. In the drawings, like numbers refer to like elements.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example aspects may be implemented at least in part by means of both hardware and software, and that several “means”, “units” or “devices” may be represented by the same item of hardware.

The different aspects, alternatives and embodiments of the disclosure disclosed herein can be combined with one or more of the other aspects, alternatives and embodiments described herein. Two or more aspects can be combined.

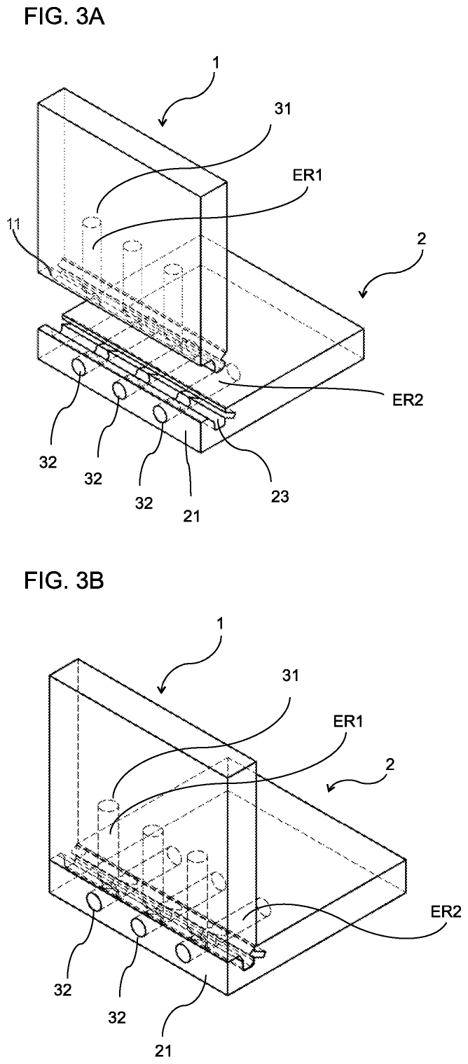

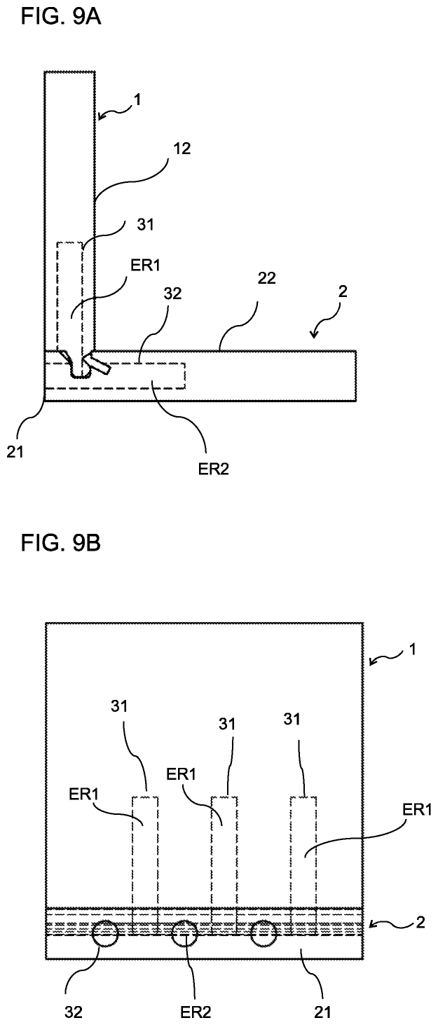

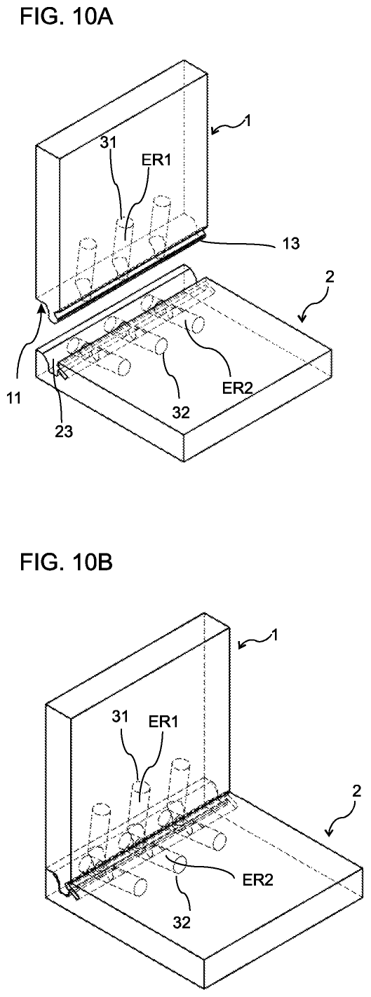

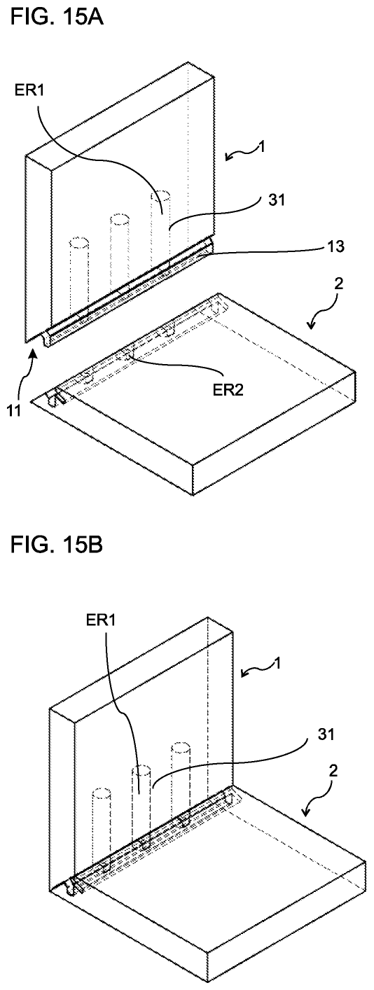

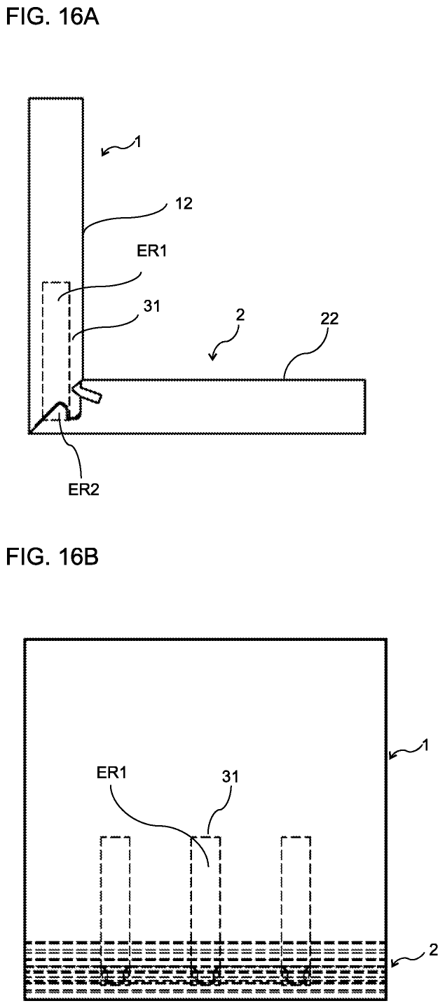

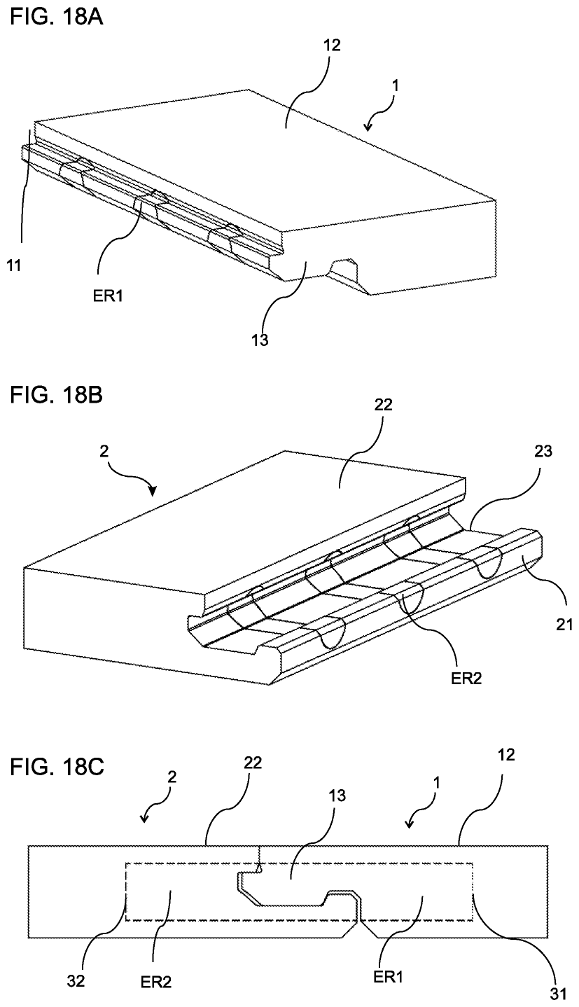

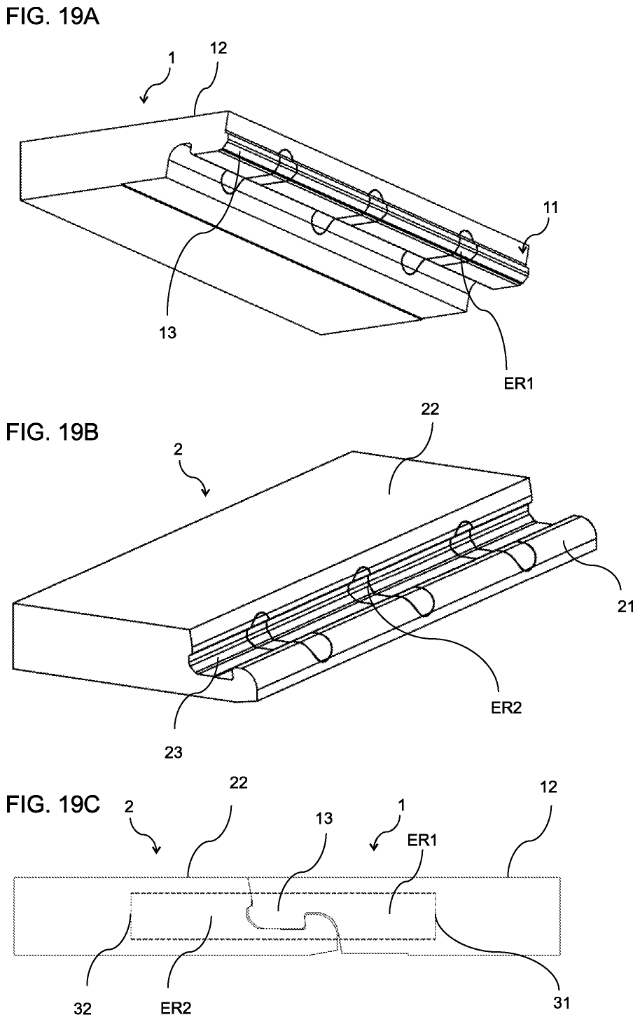

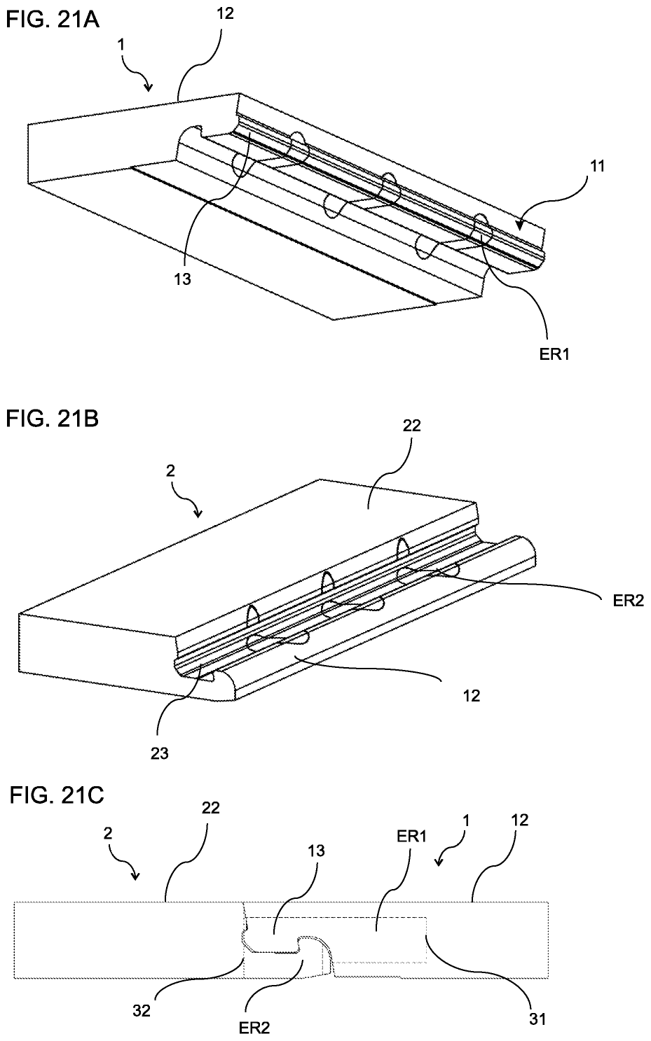

A first embodiment of the disclosure is shown, e.g., in FIGS. 3A-6C, 8A-13B, 15A-16C, 18C, 19C, 20C and 21C, including a set of panels comprising a first panel 1, a second panel 2 and a mechanical locking device for locking the first panel 1 to the second panel 2. The first panel 1 comprises a first edge 11 and a first panel surface 12 and the second panel 2 comprises a second edge 21 and a second panel surface 22. The first edge 11 comprises a first edge reinforcement ER1 in a first edge reinforcement groove 31, wherein the first edge reinforcement groove 31 is a first drill hole, and/or the second edge 21 comprises a second edge reinforcement ER2, wherein the second edge reinforcement ER2 is in a second edge reinforcement groove 32, wherein the second edge reinforcement groove 32 is a second drill hole.

The mechanical locking device for locking of the first panel 1 to the second panel 2 may comprise a tongue 13 at the first edge 11 and a tongue groove 23 at the second edge 21.

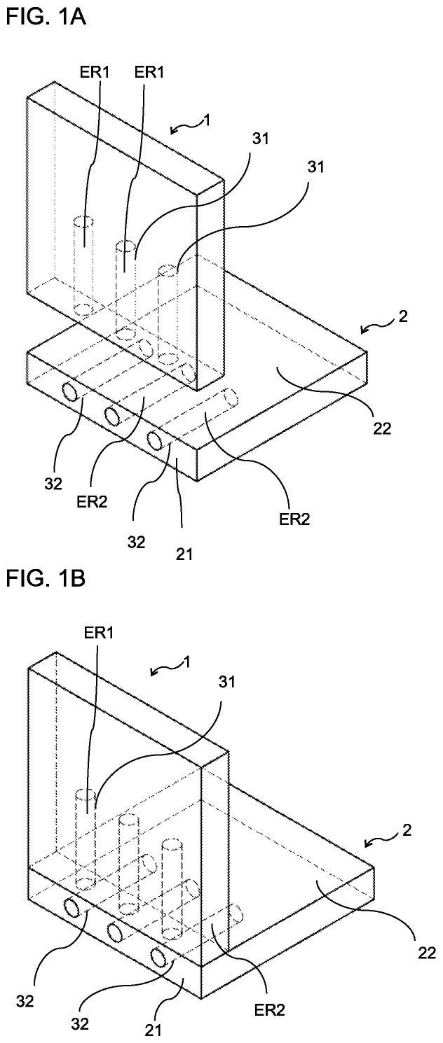

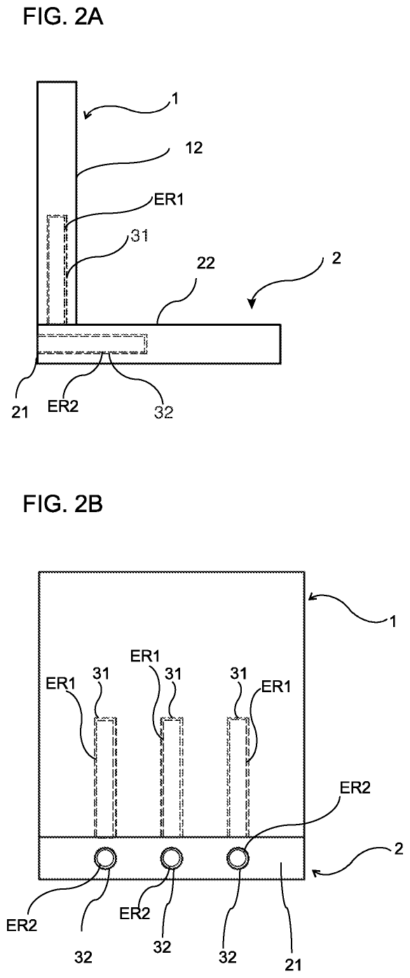

FIGS. 1A-2B, 7A-7B, and 14A show a first panel 1 and/or second panel 2 without a mechanical locking device, e.g., before being provided with a mechanical locking device. The first panel 1 comprises at least one first edge reinforcement ER1 in a first edge reinforcement groove 31 and/or the second panel 2 comprises at least one second edge reinforcement ER2 in a second edge reinforcement groove 32. After providing the first panel 1 with the first edge reinforcement ER1 and/or the second panel with the second edge reinforcement ER2, the mechanical locking device may be formed at the first and/or second edge 11,21 of the first and/or second panel 1,2. The mechanical locking device may be formed by mechanical cutting such as milling or sawing.

The first panel 1 may be provided with one or more of said first edge reinforcement ER1, such as 2, 3, 4, 5, 6, 7, 8, 9, 10, or more of said first edge reinforcement ER1. The number of said first edge reinforcement ER1 on the first panel 1 may depend on the length of the first edge 11 and strength of edge reinforcement that is wanted.

The second panel may be provided with one or more of said second edge reinforcement ER2, such as 2, 3, 4, 5, 6, 7, 8, 9, 10, or more of said second edge reinforcement ER2. The number of said second edge reinforcement ER2 on the second panel may depend on the length of the second edge 21 and strength of edge reinforcement that is wanted.

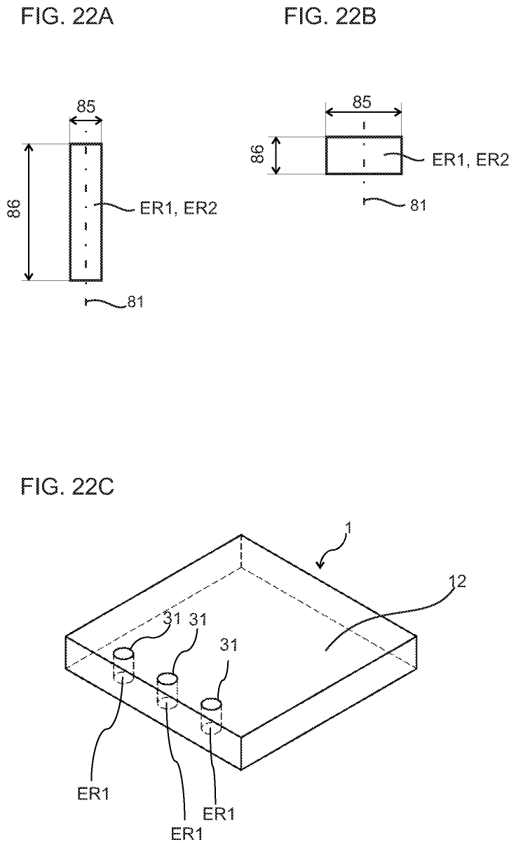

FIGS. 22A-22B show examples of edge reinforcements ER1, ER2 according to the present disclosure. The edge reinforcements ER1, ER2 may comprise a length 86, a diameter 85 and a center line 81.

The tongue 13 at the first edge 11 of the first panel 1 may comprise the first edge reinforcement ER1. This results in an increased strength of the tongue 13.

The tongue groove 23 at the second edge 21 of the second panel 2 may comprise the second edge reinforcement ER2. This results in an increased strength of the tongue groove 23.

The first edge reinforcement ER1 and the second edge reinforcement ER2 may cooperate in a locked position of the first and the second panel 1,2. In another embodiment the first edge reinforcement ER1 and the second edge reinforcement ER2 do not cooperate when the first panel 1 and the second panel 2 are in a locked position.

The first and/or the second edge reinforcement ER1, ER2 may comprise wood, a wood composite a polymer material such as a thermoplastic material selected from, e.g., PP or POM, a polymeric curing mass such as thermoset polymers selected from, e.g., polyurreas, polyurethanes, polyisocyanurates, or mixtures thereof.

In an embodiment, the first and/or second edge reinforcement ER1, ER2 may be a pin, as shown for example in FIGS. 22A-22B. The first and/or second edge reinforcement ER1, ER2 may comprise a length 86, a diameter 85 and a center line 81.

The pin may preferably be fixed to the first and/or second edge reinforcement groove 31,32 with glue, e.g., a PU, PVA or PVAc glue.

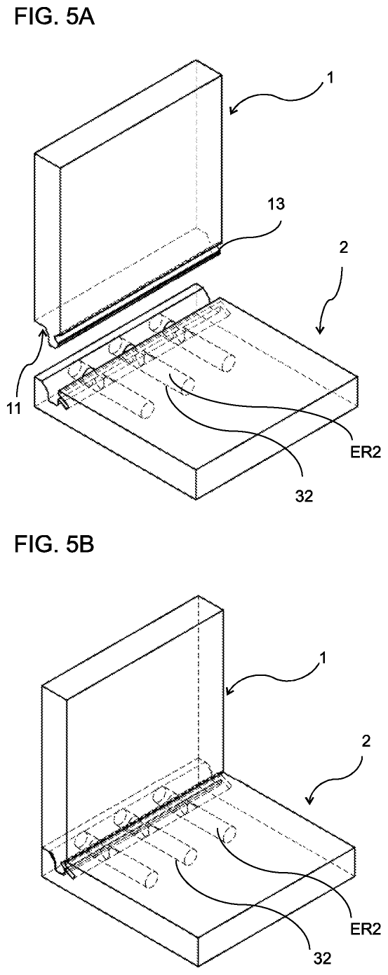

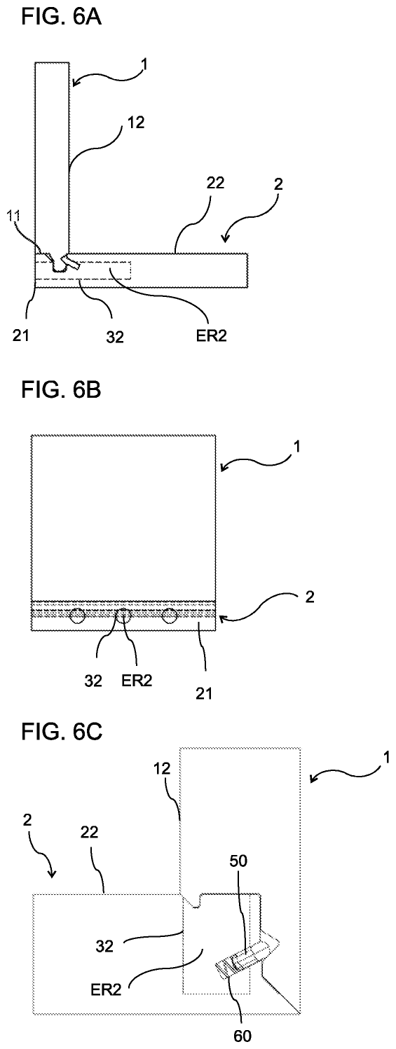

According to an embodiment of said first and/or second panel 1,2 of a set of panels comprises an edge reinforcement, as is shown in FIGS. 5A-6C, where the second panel 2 comprises a second edge reinforcement groove 32 and a second edge reinforcement ER2, while the first panel 1 does not comprise a first edge reinforcement ER1. Alternatively, the first panel 1 comprises a first edge reinforcement groove 31 and a first edge reinforcement ER1, while the second panel 2 does not comprise a second edge reinforcement ER2.

According to an embodiment, as shown in FIGS. 1A-4A, 8A-9B, 15A-21C, the center line of the first edge reinforcement groove 31 is essentially parallel with the first panel surface 12 of the first panel 1.

According to an embodiment of the disclosure, as shown in FIGS. 1A-9B, 12A-13B, 17, 18B-18C, 19B-19C, and 20B-20C, the center line of the second edge reinforcement groove 32 is essentially parallel with the second panel surface 22 of the second panel 2.

In an embodiment the center line of the first edge reinforcement groove 31 is essentially perpendicular to the first panel surface 12 of the first panel 1 as shown for example in FIG, 22C.

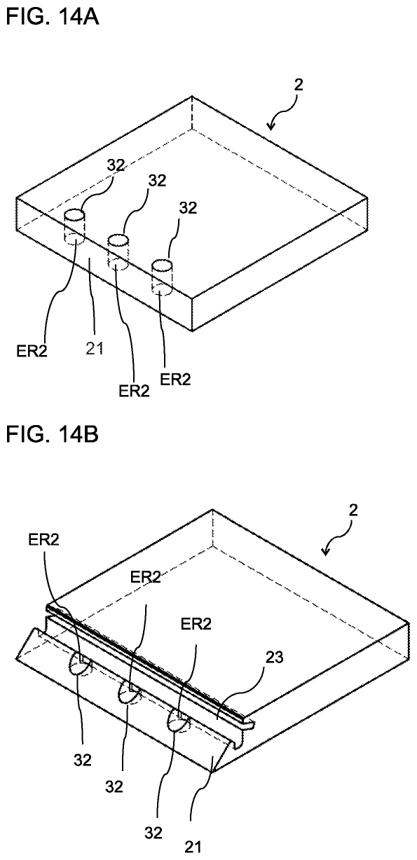

In an embodiment, shown in FIGS. 14A-16B and 21B-21C, the center line of the second edge reinforcement groove 32 is essentially perpendicular to the second panel surface 22 of the second panel 2.

The center line of the first and/or second edge reinforcement groove 31,32 may be essentially parallel to the first panel surface 12 and the second panel surface 22, respectively, and perpendicular to the first edge 11 and second edge 21, respectively.

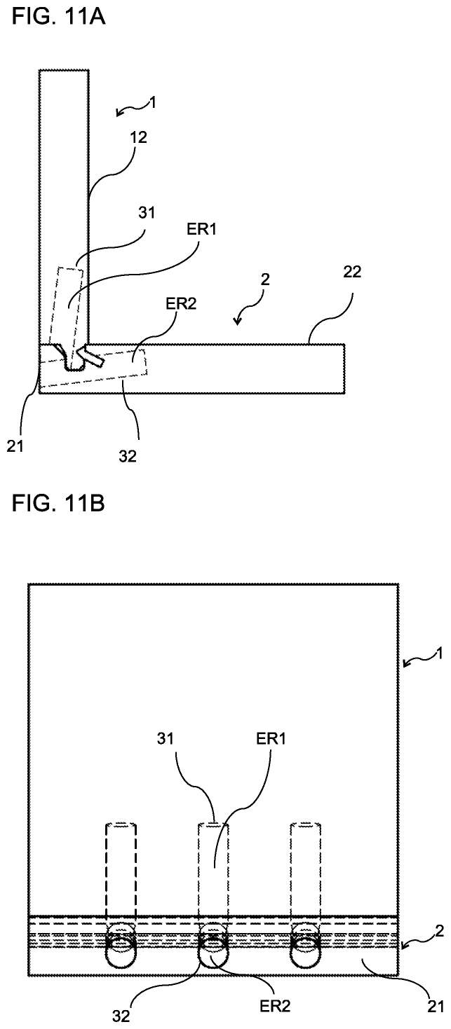

In an embodiment, as shown in FIGS. 11A-11B, the center line of the first edge reinforcement groove 31 is not essentially parallel with the first panel surface 12 of the first panel 1, but may be angled in a direction towards or, alternatively, away from the first panel surface 12. The center line of the second edge reinforcement groove 32 is not essentially parallel with the second panel surface 22, but may be angled in a direction towards or, alternatively, away from the second panel surface 22.

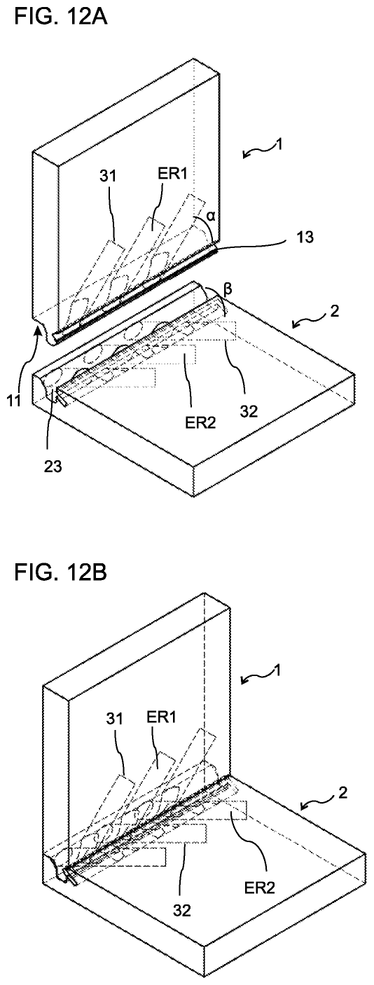

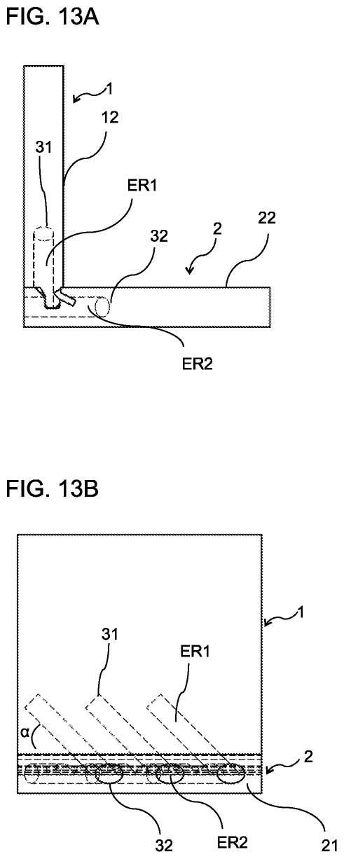

In another embodiment of the present disclosure, shown in FIGS. 12A-13B, the first edge reinforcement groove 31 may be not perpendicular to the first edge 11, i.e., an angle α between the first edge reinforcement groove 31 and the first edge 11 is ≠90°. The second edge reinforcement groove 32 may be not perpendicular to the second edge 21, i.e., an angle β between the second edge reinforcement groove 32 and the second edge 21 is ≠90°.

In an embodiment the first and/or second panel 1,2 may comprise a mix of the first and/or second edge reinforcement groove 31/32, where the first and/or second edge reinforcement groove 31/32 may be essentially parallel to the first panel surface 12 and the second panel surface 22, respectively, and also where the first and/or second edge reinforcement groove 31/32 may be essentially parallel with the first edge 11 of the first panel 1 and the second edge 21 of the second panel, respectively.

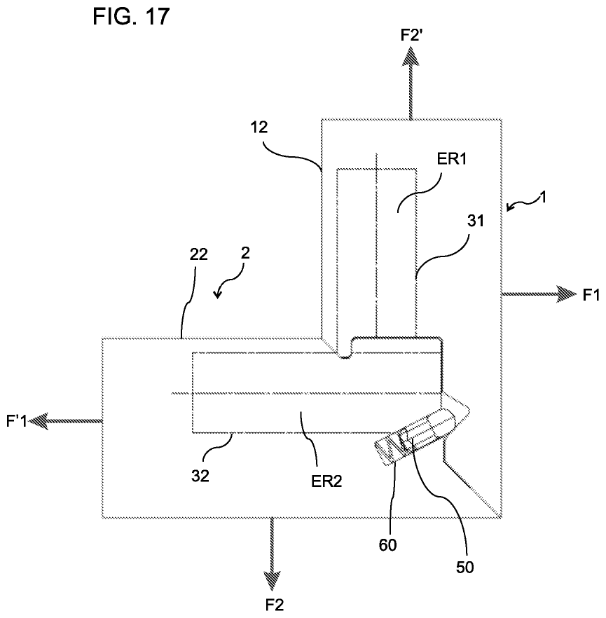

In an embodiment, as illustrated in FIG. 17, the second edge reinforcement ER2 is not positioned in the center of the second panel 2, i.e., the center line of the second edge reinforcement groove 32 differs from the center line of the second panel 2. Similarly, the first edge reinforcement ER1 does not have to be positioned in the center of the first panel 1, i.e., the center line of the first edge reinforcement groove 31 may differ from the center line of the first panel 1.

The first and/or second edge reinforcement ER1, ER2 may be part of the mechanical locking device, which results in a reinforced locking device which is more durable during assembly and/or disassembly. The reinforced edges are also beneficial after assembly of the panels, where the panels and/or the mechanical locking device can stand a higher load due to the edge reinforcement.

Strength measurements of the embodiment illustrated in FIG. 17 show an increase of strength of the mechanical locking device compared to samples without the edge reinforcement ER1, ER2. A force F2 applied to the second panel 2 in a direction perpendicular to second panel surface 22, and a counter force F2′ applied to the first panel, shows an increase of strength of the second panel of 20%. A force F1 applied to the first panel 1 in a direction perpendicular to the first panel surface 12, and a counter force F1′ applied to the second panel, shows an increase of strength of the first panel of 45%.

Specification of tested samples of exemplary embodiments in accordance with the disclosure:

Material: Melamine faced chip board

Thickness: 18 mm

Density: 640 kg/m3

Sample size: 100×100 mm

ER 1: 3 pcs of birch solid wood dowel pin, 8 mm diameter, length 40 mm

ER 2: 3 pcs of birch solid wood dowel pin, 8 mm diameter, length 40 mm

Placement of ER1 and ER2: Even distribution along the edge, 25 mm distance between each edge reinforcement ER1 and ER2.

Each edge reinforcement ER1, ER2 glued to the first/second edge reinforcement groove 31,32 with PVAc glue.

The core of the first and/or second panel 1,2 may comprise particleboard, MDF, HDF, OSB, WPC, plywood, solid wood, and/or polymeric material such as thermosetting plastic or thermoplastic such as. vinyl, PVC, PU or PET.

The core comprising polymeric material may comprise fillers such as fly ash, calcium carbonate, wood shavings, wood dust, cement and/or gypsum.

The first and/or second panel 1,2 may be provided with a decorative layer, such as a foil or a veneer, on one or more surfaces.

According to an embodiment, as, e.g., shown in detail in FIGS. 4A, 6C, 17 and 20C, the mechanical locking device may comprise a flexible tongue 50 in an insertion groove 60 for locking of the first panel 1 to the second panel 2.

The flexible tongue 50 may have longitudinal shape and the insertion groove 60 may have a longitudinal shape, wherein the flexible tongue 50 is positioned in the first insertion groove 60 with its length direction parallel with the length direction of the insertion groove 60.

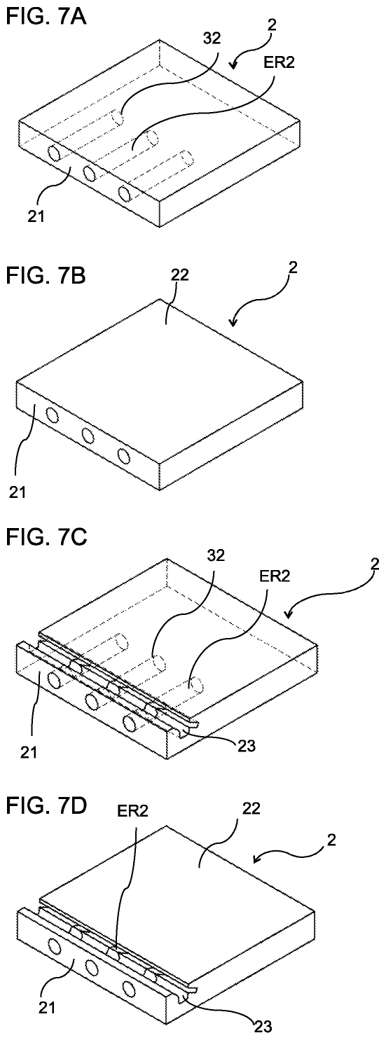

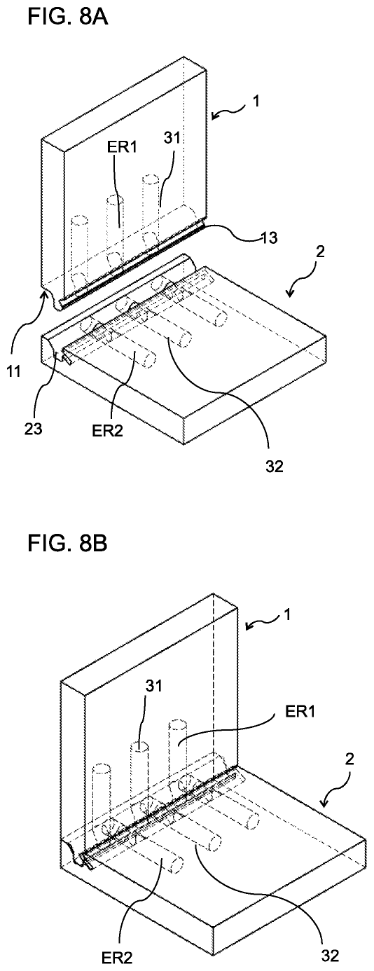

The flexible tongue may be configured as shown in, e.g., FIG. 6a-7b in WO2007/015669, or FIG. 8A-D in WO2014/209213 or FIG. 11A-13B in WO2019/203720. These figures, and the accompanying description thereof, are hereby expressly incorporated by reference.

A locking surface, configured to cooperate with the flexible tongue 50 when the first and second panel 1,2 are in a locked position, may be located on the first and/or second edge reinforcement ER1, ER2. This gives an increased strength to the mechanical locking device.

The insertion groove 60 may be positioned at least partly in the first and/or second edge reinforcement ER1, ER2.

The flexible tongue 50 may comprise a flexible material to enable compression and a displacement of the flexible tongue 50 during assembly and disassembly.

According to another embodiment the present disclosure also provides a method of providing a first panel 1 and/or a second panel 2 with a first and/or second edge reinforcement ER1, ER2. The first and/or second panel 1,2 may comprise a mechanical locking device. The first panel 1 may comprise a first edge 11 and a first panel surface 12 and the second panel 2 may comprise a second edge 21 and a second panel surface 22. The method may comprise providing the first and/or second edge 11,21 with a first and/or second edge reinforcement groove 31,32 of a cylindrical shape, arranging the first and/or second edge reinforcement ER1, ER2 in the first and/or second edge reinforcement groove 31,32, and forming a mechanical locking device at the first and/or second edge 11,21 by mechanical cutting such as milling or sawing.

The step of providing the first and/or second edge 11,21 with a first and/or second edge reinforcement groove 31,32 may be done by drilling or milling.

According to an embodiment the center line of the first and/or second edge reinforcement groove 31,32 may be essentially parallel to the first panel surface 12 and the second panel surface 22, respectively, and perpendicular to the first edge 11 and second edge 21, respectively.

The center line of the first and/or second reinforcement groove 31,32 may be essentially parallel to the first panel surface 12 and the second panel surface 22, respectively, and at an acute angle to the first edge 11 and second edge 21, respectively.

The arranging of the first and/or second edge reinforcement ER1, ER2 in the first and/or second edge reinforcement groove 31,32 may be done before the mechanical cutting

The first and/or second edge reinforcement ER1, ER2 may be formed by mechanical cutting.

For the different embodiments of the present disclosure described above, the first panel 1 and the second panel 2 may be panels for a furniture product and may be a part of a frame of a furniture product.

For a furniture product, the set is preferably configured for locking of the first panel 1 to the second panel 2 with the first panel surface 12 perpendicular or essentially perpendicular to the second panel surface 22.

For the different embodiments of the present disclosure described above, the first panel 1 and the second panel 2 may be floorboards to be locked together to obtain a floor product.

The different aspects, embodiments and alternatives described above could be combined with one or more of the other described aspects, embodiments and alternatives.

Further embodiments of the disclosure are described below.

1. A set of panels comprising a first panel 1, a second panel 2 and a mechanical locking device for locking the first panel 1 to the second panel 2, wherein the first panel 1 comprises a first edge 11 and a first panel surface 12 and the second panel 2 comprises a second edge 21 and a second panel surface 22, wherein the first edge 11 comprises a first edge reinforcement ER1 in a first edge reinforcement groove 31, wherein the first edge reinforcement groove 31 is a first drill hole, and/or the second edge 21 comprises a second edge reinforcement ER2, wherein the second edge reinforcement ER2 is in a second edge reinforcement groove 32, wherein the second edge reinforcement groove 32 is a second drill hole.

2. The set as described in embodiment 1, wherein the mechanical locking device for locking the first panel 1 to the second panel 2 comprises a tongue 13 at the first edge 11 and a tongue groove 23 at the second edge 21.

3. The set as described in embodiment 2, wherein the tongue 13 comprises the first edge reinforcement ER1.

4. The set as described in embodiment 2 or 3, wherein the tongue groove 23 comprises the second edge reinforcement ER2.

5. The set as described in any one of the embodiments 1-4, wherein the first edge reinforcement ER1 and the second edge reinforcement ER2 cooperate in a locked position of the first panel and the second panel 1,2.

6. The set as described in any one of the embodiments 1-5, wherein the first and/or the second edge reinforcement ER1,ER2 comprises wood, a wood composite, a polymer material such as a thermoplastic material selected from, e.g., PP or POM, a polymeric curing mass such as thermoset polymers selected from, e.g., polyurreas, polyurethanes, polyisocyanurates, or mixtures thereof.

7. The set as described in any one of the previous embodiments, wherein the first and/or the second edge reinforcement ER1,ER2 is a pin, wherein the pin preferably is fixed to a respective one of the first and second edge reinforcement grooves 31,32 with a glue, e.g., a PU, PVA or PVAc glue.

8. The set as described in any one of the previous embodiments, wherein the centre line of the first edge reinforcement groove 31 is essentially parallel with the first panel surface 12 of the first panel 1.

9. The set as described in any one of the previous embodiments, wherein the centre line of the second edge reinforcement groove 32 is essentially parallel with the second panel surface 22 of the second panel 2.

10. The set as described in any one of the previous embodiments, wherein the centre line of the first edge reinforcement groove 31 is essentially perpendicular to the first panel surface 12 of the first panel 1.

11. The set as described in any one of the previous embodiments, wherein the centre line of the second edge reinforcement groove 32 is essentially perpendicular to the second panel surface 22 of the second panel 2.

12. The set as described in any one of the previous embodiments, wherein the first and/or second edge reinforcement ER1,ER2 is part of the mechanical locking device.

13. The set as described in any one of the previous embodiments, wherein the mechanical locking device comprises a flexible tongue 50 in an insertion groove 60.

14. The set as described in embodiment 13, wherein a locking surface, configured to cooperate with the flexible tongue 50 when the first and second panel 1,2 are in a locked position, is located on the first and/or second edge reinforcement ER1,ER2.

15. The set as described in embodiment 13 or 14, wherein the insertion groove 60 is positioned in the first and/or second edge reinforcement ER1,ER2.

16. The set as described in any one of the previous embodiments, wherein the core of the first and/or second panel 1,2 comprises particleboard, MDF, HDF, OSB, WPC, plywood, solid wood, and/or polymeric material, such as thermosetting plastic or thermoplastic such as PVC, PU or PET.

17. The set as described in embodiment 16, wherein the core comprising polymeric material comprises fillers such as fly ash, calcium carbonate, wood shavings, wood dust, cement and/or gypsum.

18. A method of providing a first panel 1 and/or a second panel 2 with a first and/or second edge reinforcement ER1,ER2, the first and/or second panel 1,2 comprising a mechanical locking device, wherein the first panel 1 comprises a first edge 11 and a first panel surface 12 and the second panel 2 comprises a second edge 21 and a second panel surface 22, comprising providing the first and/or second edge 11,21 with a first and/or second edge reinforcement groove 31,32 of a cylindrical shape, arranging the first and/or second edge reinforcement ER1,ER2 in the first and/or second edge reinforcement groove 31,32, and forming a mechanical locking device at the first and/or second edge 11,21 by mechanical cutting such as milling or sawing.

19. The method as described in embodiment 18, wherein the step of providing the first and/or second edge 11,21 with a first and/or second edge reinforcement groove 31,32 is done by drilling or milling.

20. The method as described in any one of embodiments 18-19, wherein the centre line of the first and/or second edge reinforcement groove 31,32 is essentially parallel to the first panel surface 12 and the second panel surface 22, respectively, and perpendicular to the first edge 11 and second edge 21, respectively.

21. The method as described in any one of embodiments 18-20, wherein the centre line of the first and/or second edge reinforcement groove 31,32 is essentially parallel to the first panel surface 12 and the second panel surface 22, respectively, and at an acute angle to the first edge 11 and second edge 21, respectively.

22. The method as described in any one of embodiments 18-21, wherein the arranging of the first and/or second edge reinforcement ER1,ER2 in the first and/or second edge reinforcement groove 31,32 is done before the mechanical cutting.

23. The method as described in any one of embodiments 18-22, wherein the method comprises forming of the first and/or second edge reinforcement ER1,ER2 by mechanical cutting.

1. A set of panels comprising a first panel, a second panel and a mechanical locking device for locking the first panel to the second panel, wherein the first panel comprises a first edge and a first panel surface and the second panel comprises a second edge and a second panel surface, wherein:
the first edge comprises a first edge reinforcement in a first edge reinforcement groove, wherein the first edge reinforcement groove is a first drill hole; and
the second edge comprises a second edge reinforcement, wherein the second edge reinforcement is in a second edge reinforcement groove, wherein the second edge reinforcement groove is a second drill hole, and wherein the first edge reinforcement and the second edge reinforcement cooperate in a locked position of the first and second panels.

2. The set as claimed in claim 1, wherein the mechanical locking device for locking the first panel to the second panel comprises a tongue at the first edge and a tongue groove at the second edge.

3. The set as claimed in claim 2, wherein the tongue comprises the first edge reinforcement.

4. The set as claimed in claim 2, wherein the tongue groove comprises the second edge reinforcement.

5. The set as claimed in claim 1, wherein the first and/or the second edge reinforcement comprises wood, a wood composite, a polymer material a polymeric curing mass, or mixtures thereof.

6. The set as claimed in claim 1, wherein the first and/or the second edge reinforcement is a pin.

7. The set as claimed in claim 1, wherein the center line of the first edge reinforcement groove is essentially parallel with the first panel surface of the first panel.

8. The set as claimed in claim 1, wherein the center line of the second edge reinforcement groove is essentially parallel with the second panel surface of the second panel.

9. The set as claimed in claim 1, wherein the center line of the first edge reinforcement groove is essentially perpendicular to the first panel surface of the first panel.

10. The set as claimed in claim 1, wherein the center line of the second edge reinforcement groove is essentially perpendicular to the second panel surface of the second panel.

11. The set as claimed in claim 1, wherein the first and/or second edge reinforcement is part of the mechanical locking device.

12. The set as claimed in claim 1, wherein the mechanical locking device comprises a flexible tongue in an insertion groove.

13. The set as claimed in claim 12, wherein a locking surface, configured to cooperate with the flexible tongue when the first and second panel are in the locked position, is located on the first and/or second edge reinforcement.

14. The set as claimed in claim 12, wherein the insertion groove is positioned in the first and/or second edge reinforcement.

15. The set as claimed in claim 1, wherein the core of the first and/or second panel comprises particleboard, MDF, HDF, OSB, WPC, plywood, solid wood, and/or polymeric material.

16. The set as claimed in claim 15, wherein the core comprising polymeric material comprises fillers.

17. A method of providing a first panel and/or a second panel with a first and/or second edge reinforcement, the first and/or second panel comprising a mechanical locking device, wherein the first panel comprises a first edge and a first panel surface and the second panel comprises a second edge and a second panel surface, comprising providing the first and/or second edge with a first and/or second edge reinforcement groove of a cylindrical shape, arranging the first and/or second edge reinforcement in the first and/or second edge reinforcement groove and forming a mechanical locking device at the first and/or second edge by mechanical cutting.

18. The method as claimed in claim 17, wherein the step of providing the first and/or second edge with a first and/or second edge reinforcement groove is done by drilling or milling.

19. The method as claimed in claim 17, wherein the center line of the first and/or second edge reinforcement groove is essentially parallel to the first panel surface and the second panel surface, respectively, and perpendicular to the first edge and second edge respectively.

20. The method as claimed in claim 19, wherein the center line of the first and/or second edge reinforcement groove is essentially parallel to the first panel surface and the second panel surface, respectively, and at an acute angle to the first edge and second edge, respectively.

21. The method as claimed in claim 17, wherein the arranging of the first and/or second edge reinforcement in the first and/or second edge reinforcement groove is done before the mechanical cutting.

22. The method as claimed in claim 17, wherein the method comprises forming of the first and/or second edge reinforcement by mechanical cutting.
